(19) United States
(12) Patent Application Publication
(10) Pub. No.: US 2013/0298034 A1
(43) Pub. Date: Nov. 7, 2013

(54) DELAYED COMMAND SERVICING IN AN APPLICATION EXECUTED ON A NETWORK ACCESSIBLE DEVICE

(71) Applicants: Vinod Kumar Ramachandran, Sunnyvale, CA (US); Nareshkumar Rajkumar, San Jose, CA (US)

(72) Inventors: Vinod Kumar Ramachandran, Sunnyvale, CA (US); Nareshkumar Rajkumar, San Jose, CA (US)

(73) Assignee: Google, Inc., Mountain View, CA (US)

(21) Appl. No.: 13/462,580

(22) Filed: May 2, 2012

(51) Int. Cl. G06F 3/048; G06F 15/16; G06F 3/01

(52) U.S. Cl. 715/748; 715/835

(57) ABSTRACT

Apparatus and method for managing applications in a network accessible device. In accordance with some embodiments, an application stored in a local memory of a network accessible device is executed to provide an interactive display for a user of the device. An interactive content item is presented to the user on the display during the execution of the application. An interaction command is cached in a memory responsive to selection of the interactive content item by the user. The stored command is thereafter executed responsive to receipt of an indication that the user has terminated execution of the application.

### BACKGROUND

Mobile applications (“mobile apps”) are a class of software routines executable on various types of portable network accessible devices such as smart phones, tablets, netbooks, PDAs, smart televisions, gaming systems, etc. Some mobile applications (“preinstalled apps” or “native apps”) are installed into the device during device manufacturing. Other mobile apps (“user installed apps” or “downloaded apps”) are selectively downloadable by a user, allowing the user to customize the device based on personal preferences. User installed mobile apps can take a variety of forms such as games, communication programs, daily planners, ebook readers, geopositioning trackers, alert systems, etc.

Mobile apps are often created by developers and offered for download through an online source such as an “app store.” Developers may offer mobile apps for free or for a nominal amount, and rely on other mechanisms such as embedded advertising (e.g., “mobile ads”) to generate revenue to cover the cost of the mobile app development.

### SUMMARY

Various embodiments disclosed herein are generally directed to the management of applications in a network accessible device.

In accordance with some embodiments, an application stored in a local memory of a network accessible device is executed to provide an interactive display for a user of the device. An interactive content item is presented to the user on the display during the execution of the application. An interaction command is stored in a memory responsive to selection of the interactive content item by the user. The stored command is thereafter executed responsive to receipt of an indication that the user has terminated execution of the application.

These and other features and advantages which may characterize various embodiments can be understood in view of the following detailed discussion and the accompanying drawings.

### BRIEF DESCRIPTION OF THE DRAWINGS

FIG. 1 provides a functional block representation of a network-based system in accordance with various embodiments.

FIG. 2 shows aspects of the system of FIG. 1 in accordance with some embodiments.

FIG. 3 represents a display generated during the execution of a mobile app that includes an invitation communication in the form of a mobile ad.

FIG. 4 is a functional block representation of operations that may be carried out in response to the user accepting the invitation communication in FIG. 3.

FIG. 5 is a sample format for a command queue.

FIG. 6 provides a flow chart for a routine illustrative of steps that may be carried out in accordance with various embodiments.

### DETAILED DESCRIPTION

The present disclosure generally relates to the management of mobile applications (“mobile apps”) in a network accessible device, and more particularly, to the ability to delay execution of an action by a user during the ongoing execution of an application.

It is becoming increasingly common to display interactive content items, such as advertisements or other sponsored content, within the context of a currently executing mobile app. Configuring an application to accept such items may lead to increased revenue opportunities for the developer of the app.

Some mobile ads include a creative portion which may involve text, graphics, images or video files associated with the advertised service and/or product. Mobile ads displayed in mobile applications may offer an upgrade to the existing mobile app, or may offer other mobile apps that are available from the developer. In addition, the mobile ads may be for third party mobile applications, products or services not directly associated with the developer of the mobile app.

Mobile ads may further have an interactive portion such that user selection (a “click”) of the advertisement will direct the user to additional information related to the advertisement. The interactive portion of an ad can take a variety of forms. For example, advertisements can be configured such that, upon selection, the user is connected to a linked web page with additional information, often referred to as a “landing page.” Some advertisements may have forms or fields to “pre-load” searches or other operations on the landing page associated with the ad.

Other advertisements may have a “click to call” feature that enables a user to call (establish a telephonic connection with) the advertiser directly from the ad via clicking on a virtual button. Still other advertisements may have a “click to chat” feature that opens a chat window directly from a virtual link or button on the advertisement creative to enable the user to chat with a representative associated with the ad.

A “click to purchase” feature allows users to carry out a purchase transaction for an advertised product or service. Similarly, a “click to download” feature can initiate a transaction that takes the user to an app store to purchase the advertised app.

These and other interactive ad formats may result in the termination of the then currently executing mobile app in order to service the ad (e.g., initiate the purchase and download of a new app, etc.). The premature termination of the existing mobile app may lead to an unintended loss of data for the user, such as by losing ongoing progress within a game, losing a partially written communication, etc. Users may thus become reluctant to click on ads or other invitations to action within an existing app, and may not follow up and pursue the download of a new app that was presented to the user once the mobile app is completed.

Accordingly, various embodiments of the present disclosure are generally directed to an apparatus and method for delaying execution of an action selected by a user of an application until the user affirmatively terminates the execution of the app. As explained below, during the execution of a mobile app, the user is presented with an interactive content item that presents an invitation for the user to take action, such as in the form of a mobile ad. The interactive content item is configured such that the user can accept the invitation without terminating the continued execution of the existing mobile app. The action is not actually taken until the user terminates the existing app.

This decoupling of the user's intent to take action, and the actual taking of the action at a later time, reduces the premature loss of ongoing progress in the existing mobile app. This may increase the user's willingness to interact with the presented content.

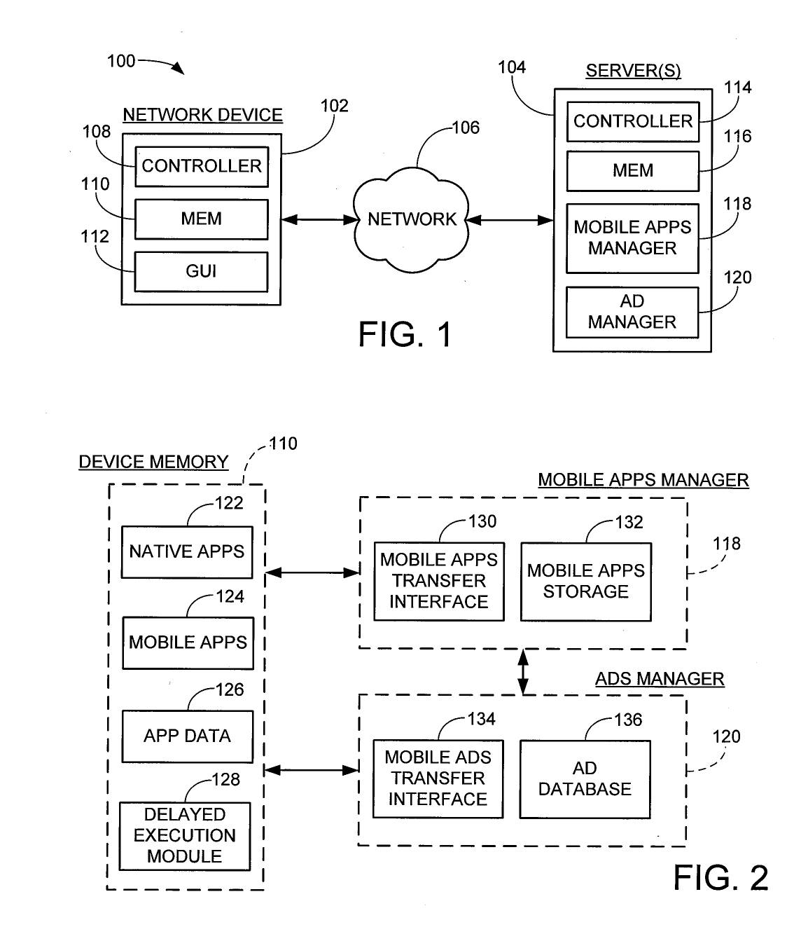

These and other features and benefits can be understood beginning with a review of FIG. 1, which depicts a network-based, dynamic content transfer system 100 constructed and operated in accordance with various embodiments. The system 100 includes a number of components, including a mobile network accessible device 102 and one or more servers 104. The device 102 and server(s) 104 communicate over a network 106, such as a wide area network (WAN), a local area network (LAN), a broadband wireless network, etc.

The network accessible device 102 can take a variety of forms, including but not limited to a laptop computer, a tablet, a smart phone or some other portable network accessible appliance adapted to download and execute mobile apps. The device 102 is shown to include a controller 108, local memory (mem) 110 and a graphical user interface (GUI) 112. Other components may be incorporated into the device.

The controller 108 may be a hardware-based or programmable processor which provides top level control of the device 102 responsive to inputs supplied by a user of the device 102 via the GUI 112. The device memory 110 stores information input by the user, programming and/or control information utilized by the controller 108, and information transferred to the device 102 over the network 106.

The GUI 112 may include a keyboard, keypad, mouse, monitor, touch screen, touch pad, microphone, game controller, and/or other suitable components to enable human comprehensible interaction with and/or control of the device 102. It is contemplated, although not necessarily required, that the execution of a downloaded mobile app from the memory 110 can be executed by user interaction with the GUI 112, and the resulting execution of the mobile app will display interactive A/V content on the GUI 112.

The server 104 can take a variety of forms, and is shown in FIG. 1 to include a controller 114, server memory (mem) 116, a mobile apps manager 118 and an ad manager 120. It will be appreciated that the managers 118, 120 may be realized in hardware, software and/or firmware, and may reside on the same server or on distinct servers each having associated controllers and memory spaces to facilitate intercommunication via the network 106. Thus, while only a single network accessible device 102 and a single server 104 are shown in FIG. 1, it will be appreciated that any number of respective devices and servers can be interconnected and utilized in accordance with the present disclosure.

As explained below, a user of the device 102 can access the server(s) 104 to download a mobile app from the mobile apps manager 118 to local device memory 110. During subsequent execution of the mobile app, the ad manager 120 may supply one or more mobile ads (or other interactive content items) responsive to requests for such by the mobile app.

FIG. 2 illustrates aspects of the system 100 of FIG. 1 in accordance with some embodiments. The device memory 110 may be a contiguous memory space or made up by a single memory device such as a solid-state memory array or a disc-based memory. Alternatively, the device memory 110 may represent various memory devices within the mobile device 102, including such elements as main memory, a hierarchical cache, I/O data buffers and local processor (L1-L3) cache. The memory 110 may be volatile, non-volatile or a combination of both. The memory 110 stores various operational modules, including native applications (apps) 122, user downloaded mobile apps 124, application (app) data space 126, and a delayed execution module 128. Other programming layers, such as a device operating system, may also be provided as desired.

The native apps 122 will vary depending on the configuration of the device 100 and generally represent software routines loaded onto and supplied with the device by the manufacturer. In some embodiments, the native apps may include routines such as web browsers (e.g., Safari, etc.), telephone communication routines, video/still camera software, weather alert routines, word processing applications, clock and timing utilities, calculator displays, interface links to app stores, and so on.

The mobile apps 124 represent software routines specifically downloaded by the user for use on the device. The mobile apps can take a variety of forms including games, communication programs (e.g., third party email, chat and texting systems, etc.), daily planners, ebook readers, geopositioning trackers, alert systems, and so on. Both the native apps 122 and the user downloaded apps 124 may be represented on the GUI 112 (FIG. 1) as icons that are individually selectable by the user as desired.

The app data space 126 represents a portion of the local memory 110 allocated for the storage of control data associated with the respective execution of the native and downloaded mobile apps 122 and 124. Segregated data areas may be provided for these respective types of apps; for example, separate caches, history and cookie areas may be maintained for the various apps, both by type (native v. user) and on an individual app basis. Device level data, such as a unique device identification value (e.g., a “device ID”) may also be stored in the app data space 126. Depending on device configuration, the user may or may not have direct access to the app data stored in the app data space 126, and may or may not be able to delete, alter or overwrite data stored therein.

The delayed execution module 128 may be a stand-alone module, or may be incorporated as a portion of one or more of the mobile apps 124. In some embodiments, the delayed execution module 128 may form a portion of the software development kit (SDK) functionality of the mobile apps 124 that are configured in accordance with the present disclosure. As explained below, in some embodiments, the delayed execution module 128 operates to locally store data indicative of the user's intent to take action, to detect the user's termination of the mobile app in which the intent was expressed, and to automatically initiate the intended action such as by contacting an appropriate remote site via the network 106 (FIG. 1) to commence a desired data exchange.

The mobile apps manager 118 is shown in FIG. 2 to include a mobile apps transfer interface block 130 and a mobile apps storage space 132. Other modules can readily be incorporated. The interface block 130 generally operates to facilitate data transfers with the device 102, including the downloading of requested mobile apps 124 from the storage space 132 and the servicing of requests for data from the device 102 associated with the execution of the mobile apps 124. The mobile apps storage space 132 represents a storage area for a number of different mobile apps available for download to the device, such as through an application provider (“app store”). The mobile apps storage 132 may be provided via a cloud computing and storage system and may interface with a variety of third party suppliers of applications to provide the various available mobile apps.

The ad manager 120 includes a mobile ads transfer interface block 134 and an ad database 136. The ad manager 120 generally operates to receive requests for mobile ads and, in response thereto, proceeds to select and transfer one or more appropriate ads from the mobile ad database 136 for display on the local device 102. As before, the ad manager 120 may incorporate a number of additional modules including cloud computing and storage capabilities.

For purposes of providing a concrete example, it is contemplated in FIG. 2 that a selected mobile application, referred to herein as “app 1,” has been selected for download by the user of the device 102 to the mobile apps memory block 124. The selection process may be a result of the user responding to a mobile ad presented in another, previously downloaded mobile app, or through some other mechanism such as through one of the native apps. For example, the user may have requested the download by accessing a link in the native apps 122 to a particular app store associated with the mobile apps manager 118.

The successful download of the app 1 mobile app results in the display of an associated icon on the GUI 112 of the local device 102. User selection of the icon commences the execution of the app 1 mobile app. User termination of the app 1 mobile app may occur by the user selecting an exit button presented within the display of the app 1 mobile app, or by user selection of a power down or exit button on the device 102. While not limiting, it is contemplated that the app 1 mobile app will constitute an interactive game that involves user manipulation of animated characters presented on the GUI 112, such as incensed fowl which are catapulted by the user at a selectable trajectory toward self-satisfied boar.

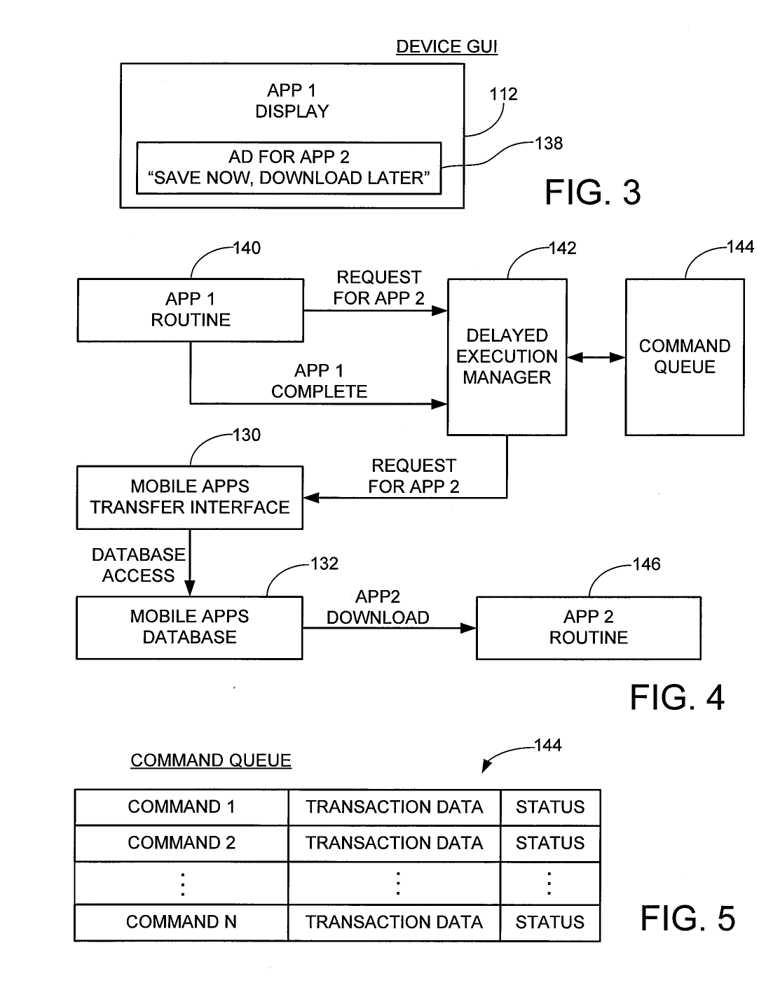

The execution of the app 1 routine results in a display on the GUI 112, as generally represented in FIG. 3. At some point during such execution, a mobile ad for a second mobile app, referred to as “app 2,” will be displayed as generally indicated at block 138. While not limiting, for purposes of the current example it is contemplated that the app 2 mobile app is another game offered by the developer of app 1.

The mobile ad may be displayed responsive to a request for communication generated by the execution of app 1. This request may be directed to the mobile apps manager 118 and forwarded to the ad manager 120, or may be transferred directly to the ad manager 120 by the device 102. Regardless, processing of the communication results in the transmission and display of the ad for app 2 from the ad database 136 (see FIG. 2).

It will be noted that the ad 138 in FIG. 3 includes the phrase “save now, download later.” While not necessarily required, a communication to the user such as this provides assurance that the user may safely select the app 2 mobile app now, and the app will be downloaded at a later time. Other suitable language can be incorporated into the ad, although no such language need be supplied. Subsequent screens can be provided, such as a confirmation screen, a thank you screen, etc. Once selected, the screen(s) disappear and the user continues playing the app 1 game.

FIG. 4 provides a functional block representation of various operations of the system of FIGS. 2-3 in accordance with some embodiments. The app 1 routine is represented at block 140. At some point during this execution, the ad 138 is displayed and, responsive to the user selecting the ad, the routine 140 outputs a data signal to a delayed execution manager 142 of the delayed execution module 128 (FIG. 2). An associated interaction command is temporarily stored in a buffer memory of the device 102 in the form of a command queue 144. The queued command 144 can take any variety of forms. In some embodiments, a queue structure is used to accommodate multiple queued requests for download or other actions by the user. In some embodiments, commands from different mobile apps can be accumulated into the command queue 144 for delayed execution at a later time.

Once the user takes one or more steps to terminate the execution of the app 1 routine 140, an “app 1 complete” signal is provided to the delayed execution manager 142. The signal provides an affirmative indication that the app has terminated execution. Such termination may involve a complete exiting of the routine, or the placement of the routine by the user in a non-executing suspended state. It is not necessarily required that programming instructions associated with the app be removed from local processor cache or other processor memory locations in order for the app to be terminated, although the termination can involve such steps as desired. While a specific communication signal is shown, the manager 142 can detect user termination of the app 1 routine 140 in a variety of ways, including through the detection of commencement of a new application, user selection of a deactivation button on the device 102, etc.

In response to the detected termination of app 1, the manager 142 transmits the queued interaction command to the mobile apps transfer interface block 130 (see FIG. 2). The interface block 130 proceeds to transfer the selected app 2 mobile app, denoted by block 146, from the mobile apps database 132 to the local device memory 110. While not specifically shown in FIG. 4, this download operation may include a number of data exchanges, including device identification and payment operations, between the user and the mobile apps manager 118.

The cached command information in the queue 144 can take a variety of forms. In some embodiments, the command information may include a URL or other network address for use by a native app 122 of the device 102 (e.g., a web browser, etc.) to connect the device 102 to a remote site, such as a landing page. In other embodiments, a unique identifier tag is provided in the embedded mobile ad, and this tag value is stored and subsequently transferred to the mobile apps manager 118 to signify a request for the download of the app 2 mobile app. In further embodiments, information relating to the then-existing app 1 mobile app is included in the command to allow tracking of the effectiveness of the ad campaign.

FIG. 5 provides a schematic representation of a command queue format in accordance with some embodiments. The command queue 144 is shown to accommodate up to N commands, with associated transaction data and status indicator fields. While not depicted in FIG. 4, it is contemplated that the successful completion of the queued request will be reported to the delayed execution manager 142, enabling the manager to remove the cached request from the queue 144. Alternatively, the cached command can be retained and marked with a status flag such as “command complete” once the download has been successfully completed. Other information, such as a date stamp can also be recorded at this time.

While local caching of the commands is generally represented in FIG. 4, it will be appreciated that such is merely illustrative and not necessarily limiting. For example, the caching of the delayed execution commands may instead be provided at the server level (e.g., by the mobile apps manager 118), or caching of the commands may take place at both ends (e.g., locally, and at the server level). Command complete processing can be used to ensure that all outstanding commands have been successfully executed. If server level caching is provided, the device can be configured to forward a signal across the network to the server that indicates the user has terminated the app.

User termination of the app 1 routine 140 can be carried out in a variety of ways. In some embodiments, selection of an “exit” or “close” button within the GUI 112 presentation of the app 1 content can be detected and used to signify termination of the application. Alternatively, user activation of a power down or main screen activation button can be used. It is contemplated that the queue may be configured to retain the download command in the queue in the event of a loss of power or other interruption of the app 1 routine, such as to service an incoming call, etc. Data transfer or backup techniques can be used to store and/or transfer the command queue to non-volatile memory in order to retain the user's intent to download even in the loss of battery power or intentional power down of the device.

It is noted that mobile apps are often configured to detect a data transfer request (e.g., the downloading of a second mobile app) and to automatically terminate in response. In such case, the delayed execution of the commands as discussed herein enable such mobile apps to operate as normally configured and may not necessarily require modifications to their programming in order to support this delayed execution functionality. This can be beneficial since it is often cumbersome to update the programming of an existing mobile app that has already been downloaded onto a device.

The manager 142 can be configured to maintain a history of downloaded apps that have passed through the processing sequence of FIG. 4. The history can be subsequently transferred to the mobile apps manager 118, allowing the effectiveness of various ad campaigns to be evaluated. The history data may enable developers to evaluate the placement, frequency and types of ads that are most effective in a mobile app context.

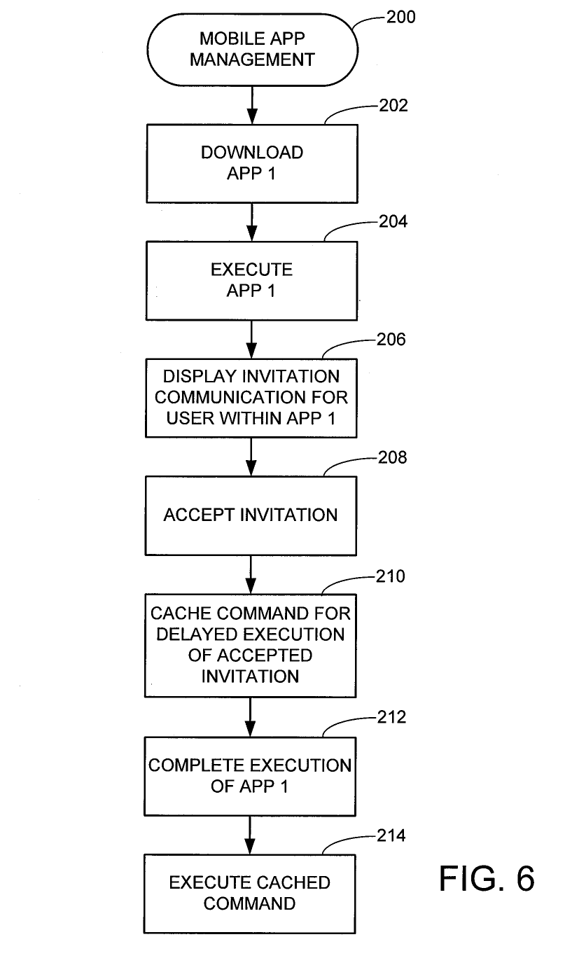

FIG. 6 provides a flow chart for a MOBILE APP MANAGEMENT routine 200 illustrative of various steps that may be carried out in accordance with the foregoing discussion. The steps may be representative of programming supplied in a mobile app downloaded to a network accessible device such as the device 102 in FIGS. 1-2.

At step 202, a first mobile app is downloaded to the device, such as the app 1 routine 140 in FIG. 4. This app is executed at step 204 by the user, resulting in the generation of a GUI 112 display as depicted in FIG. 3. At some point during the execution of the app, an invitation communication to the user is displayed within the context of the first app, step 206.

While the foregoing discussion has contemplated the invitation communication as an advertisement for a second mobile app, such is merely illustrative and not limiting. The invitation to take action may take any variety of forms such as a public service announcement, an advertisement for a political candidate, an opportunity to contribute to a social movement or relief fund, a request to sign a petition or other organized activity, an invitation to comment upon or indicate approval of the first app in a social network, an offer to purchase a physical item such as a book or movie tickets, and so on.

At step 208, the user accepts the invitation extended in step 206. This may be carried out in a variety of ways. The user may “click” on the advertisement by moving a pointer, activating a user button on the device, tapping on a touch screen, or performing some other interactive operation via the GUI 112 to signify acceptance. Alternatively, the user may be given an opportunity to enter information such as making selections or entering text as part of the accepted invitation. A thank you style screen may be displayed upon acceptance, indicating that the requested action (download, etc.) will commence at the conclusion of the app 1 routine.

In some embodiments, one-click shopping may be activated so that, upon selecting the ad, all information necessary to complete the transaction, including payment information, is stored locally such as in the app data space 126 of local memory 110 (FIG. 2). The data are automatically transferred to the mobile apps manager 118 so that no further steps are required on the part of the user to complete the download of the requested new app apart from terminating the existing app.

Continuing with the routine 200 of FIG. 6, an interactive command associated with the accepted invitation is cached in a buffer memory at step 210. The command may be stored in a command queue as discussed in FIG. 4, or some other memory such as at the server level. Multiple pending commands may be cached as shown in FIG. 5. The user resumes interaction with the first app until such time that the user terminates further execution, step 212, after which the cached command is retrieved from the command queue and executed, step 214.

It is contemplated that the user termination of the first mobile app will trigger immediate execution of the cached command; however, such is not necessarily required. In some embodiments, the cached command may be executed by the device at some other specified time. For example, a timer may be initiated that starts an elapsed time interval counting from the completed execution of the mobile app, so that the command is carried out a selected period of time (e.g., 4 hours, etc.) after termination of the execution of the mobile app by the user. Alternatively, a particular time in the future may be selected (e.g., 2:00 a.m., etc.) to carry out the download or other action after the termination of the app.

In some embodiments, the delayed execution module may ask the user whether the user wishes to proceed with the download now or to wait until the first mobile app is terminated, along with a reminder that any unsaved progress will be lost if the download proceeds. It is noted that such affirmative action on the part of the user would result in the deliberate termination of the first app, so that the user is aware that the first app will not continue execution if the download is commenced now. Thus, for purposes of the appended claims, user termination of the mobile app will be understood consistent with the foregoing discussion to signify a deliberate intention on the part of the user to terminate the application, rather than the termination inadvertently occurring as a result of an action taken by the user.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
executing an application stored in a local memory of a network accessible device to provide an interactive display for a user of the device;
presenting an interactive content item to the user on the display during the execution of the application;
responsive to selection of the interactive content item by the user, storing an interaction command in a memory; and
executing the stored command responsive to receipt of an indication that the user has terminated execution of the application.

2. The method of claim 1, in which the interactive content item is a click to download item, a click to call item, a click to chat item or a click to purchase item.

3. The method of claim 1, in which the command is stored in the local memory of the device.

4. The method of claim 1, in which the command is stored in a remote server in communication with the device via an intervening network.

5. The method of claim 1, in which the stored command is executed by contacting, via a network, a remote server and transferring data from the remote server to the local memory of the network accessible device.

6. The method of claim 1, in which the storing and executing steps are carried out by a software development kit (SDK) associated with the application.

7. A method comprising:
receiving, from a network accessible device, a request for an interactive content item to be displayed in conjunction with an application executing on the network accessible device;
responsive to the request, selecting an interactive content item from a plurality of available interactive content items stored in a memory, said interactive content item including an interaction command adapted to be temporarily stored in a memory upon user selection of the interactive content item and executed upon user termination of the application; and
transferring the interactive content item over a network to the network accessible device.

8. The method of claim 7, in which the request is generated by the application during execution thereof on the network accessible device.

9. The method of claim 7, further comprising:
receiving, from the network accessible device, the interaction command; and
storing the interaction command in the memory.

10. The method of claim 7, further comprising:
transferring a second application to the network accessible device responsive to the execution of the stored interaction command.

11. The method of claim 7, in which the execution of the stored command transfers a landing page to the network accessible device.

12. The method of claim 7, in which the interactive content item is a click to download item, a click to call item, a click to chat item or a click to purchase item.

13. The method of claim 7, in which the application is a user downloaded application which generates a visual display on a graphical user interface (GUI) of the device, and the interactive content item displays an advertisement to the user during said visual display for a second application available for download to the device.

14. The method of claim 7, in which the interaction command is executed by the network accessible device contacting, via the network, a remote server and transferring data from the remote server to the local memory of the network accessible device.

15. An apparatus comprising:
a processor; and
a memory which stores programming for the processor adapted to, responsive to receipt of a request from a network accessible device for an interactive content item to be displayed in conjunction with an application executing on the network accessible device, perform steps of:
selecting an interactive content item from a plurality of available interactive content items stored in the memory, said interactive content item including an interaction command adapted to be temporarily stored in a memory upon user selection of the interactive content item and executed upon user termination of the application; and
transferring the interactive content item over a network to the network accessible device.

16. The apparatus of claim 15, in which the request is generated by the application during execution thereof on the network accessible device.

17. The apparatus of claim 15, in which the programming is further adapted to perform a step of storing the interaction command in the memory responsive to receipt of the interaction command from the network accessible device.

18. The apparatus of claim 15, in which the programming is further adapted to perform a step of transferring a second application to the network accessible device responsive to the execution of the stored interaction command.

19. The apparatus of claim 15, in which the execution of the stored command transfers a landing page to the network accessible device.

20. The apparatus of claim 15, in which the interactive content item is a click to download item, a click to call item, a click to chat item or a click to purchase item.

21. The apparatus of claim 15, in which the processor and the associated memory form a portion of a server connected to the network accessible device via the network, and the interaction command is stored by the server pending termination by the user of the application.

22. The apparatus of claim 15, in which the processor and the associated memory form a portion of a server connected to the network accessible device via the network, the server providing the selected interactive content item to the device and providing a second application to the device responsive to execution of the stored interaction command.
